(19) United States
(12) Patent Application Publication
(10) Pub. No.: US 2026/0255462 A1
(43) Pub. Date: Aug. 27, 2026

(54) HEADLIGHT FOR A MOTOR VEHICLE

(71) Applicant: HELLA GMBH & CO. KGAA, Lippstadt (DE)

(72) Inventors: Sebastian Gatsios, Arnsberg (DE); Florian Herold, Bielefeld (DE); Patrick Vogel, Unna (DE); Ingo Möllers, Rietberg (DE)

(21) Appl. No.: 18/861,652

(22) PCT Filed: May 8, 2023
(86) PCT No.: PCT/EP2023/062110

§ 371 Date: Oct. 30, 2024

(30) Foreign Application Priority Data
May 24, 2022 (DE) 102022113095.9

(51) Int. Cl. H05B 47/18; B60Q 1/00; B60Q 1/14; H05B 45/10; H05B 45/325

(52) U.S. Cl. CPC H05B 47/18; B60Q 1/0088; B60Q 1/1423; H05B 45/10; H05B 45/325

(57) ABSTRACT

The invention relates to a headlight for a motor vehicle, comprising: a light source module having a plurality of light-emitting diodes, which are arranged in the form of a matrix or an array, the plurality of light-emitting diodes being designed to produce pixels of a light distribution; an Ethernet interface, which is designed to receive image data for the light-emitting diodes and to process said image data further; wherein the light source module has an integrated circuit, on or in which both the plurality of light-emitting diodes and the Ethernet interface are formed.

### CROSS-REFERENCE TO RELATED APPLICATIONS

This application is the National Stage of International Application No. PCT/EP2023/062110 filed on May 8, 2023, which claims priority to and all advantages of German Patent Application No. 10 2022 113 095.9 filed on May 24, 2022, the disclosures of which are hereby incorporated by reference in their entirety.

### BACKGROUND

The present invention relates to a headlight for a motor vehicle.

A headlight and a motor vehicle of the aforementioned type are known from US 2021/0107397 A1. The motor vehicle described therein comprises a control device for controlling a high-resolution headlight with a large number of light-emitting diodes (LEDs) arranged in the form of a matrix. The control device has an Ethernet interface that transmits image data for controlling the LEDs to an Ethernet interface located in the headlight. The Ethernet interface of the headlight is connected to a microcontroller of the headlight, which controls the light-emitting diodes depending on the image data received. The design described in this document is comparatively complex and has a large number of different components.

### SUMMARY

The problem underlying the present invention is the creation of a headlight of the type mentioned at the beginning, which has a less complex structure and/or fewer components. Furthermore, a motor vehicle with such a headlight should be indicated.

According to the invention, this is achieved by a headlight of the type mentioned at the beginning with the features set forth herein and by a motor vehicle of the type mentioned at the beginning with the features set forth herein.

According to one embodiment, it is provided that the light source module has an integrated circuit (IC) on or in which both the plurality of light-emitting diodes and the Ethernet interface are formed. This makes the headlight less complex. Furthermore, the number of headlight components is reduced. In particular, the design according to the invention can eliminate the microcontroller of the headlight used in the prior art, which is usually placed on a separate control unit, receives the image data via the Ethernet interface from the control device of the motor vehicle and converts it into a format suitable for current sources of the light-emitting diodes.

It may be provided that the integrated circuit has current source drivers to power the light-emitting diodes. The integrated circuit can be set up to convert the image data received via the Ethernet interface into pulse width modulation signals to control the current source drivers. The reception and conversion of the image data as well as the control of the light-emitting diodes can therefore take place completely within the integrated circuit.

It is possible for the light source module to have a converter component that adapts the voltage level of the incoming Ethernet signals to the voltage level of the integrated circuit, in particular wherein the converter component is arranged outside the integrated circuit. This converter component does not change or decode the image data, but merely reduces the voltage amplitudes of the Ethernet signals. Alternatively, the converter component can also be integrated into the integrated circuit.

It may be provided that the headlight comprises a power control unit having a power supply for the light-emitting diodes and a control unit controlling the power supply, wherein the power control unit is connected to the light source module via a supply cable. The power control unit is not used to control the light-emitting diodes with image data, but merely fulfills the function of a suitable voltage source for the integrated circuit and the light-emitting diodes arranged on it.

It is possible that the integrated circuit is designed as a solid-state LED array, in particular as an SSL chip, preferably as an SSLIHD chip.

According to another embodiment, the motor vehicle comprises a headlight according to the invention.

It may be provided that the motor vehicle comprises a light control unit with a control device for controlling the light-emitting diodes of the headlight. The light control unit can have an Ethernet interface for transmitting image data from the control device to the Ethernet interface arranged in the integrated circuit. In particular, the Ethernet interface of the light control unit and the Ethernet interface of the integrated circuit can be connected to one another via an Ethernet cable or an Ethernet bus and, if necessary, via the converter component.

### BRIEF DESCRIPTION OF THE DRAWINGS

The invention is explained in more detail below with reference to the attached drawing. In the figures:

FIG. 1 shows a schematic representation of a headlight according to the invention and a light control unit of a motor vehicle according to the invention which interacts with the headlight.

In the figure, identical and functionally identical parts are marked with the same reference symbols.

### DETAILED DESCRIPTION

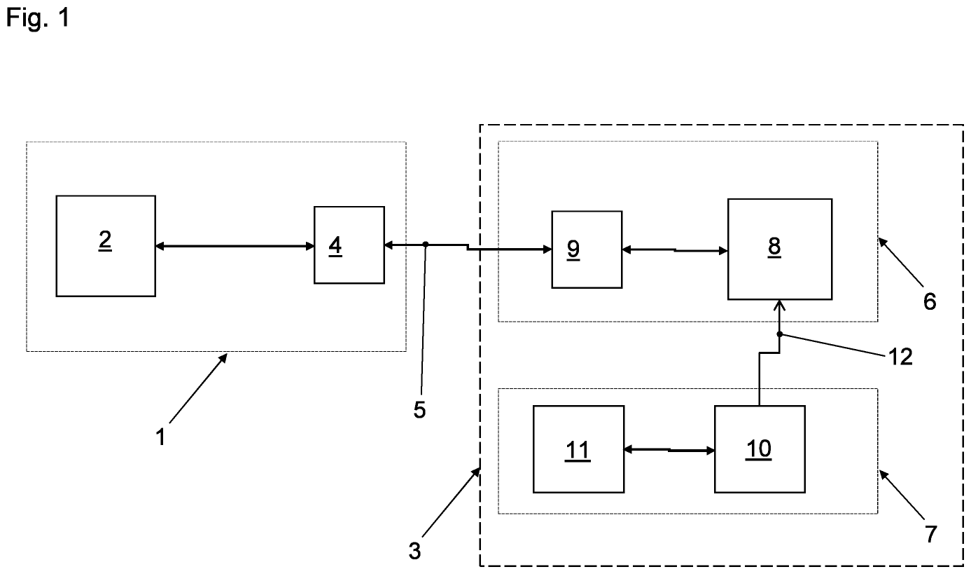

A light control unit of the motor vehicle provided with the reference sign 1 in FIG. 1 as a whole comprises a control device 2 which can generate image data for controlling the headlight provided with the reference sign 3 as a whole. The light control unit 1 also comprises an Ethernet interface 4 connected to the control device 2, via which the image data generated by the control device 2 can be output. The Ethernet interface 4 is connected to the headlight 3 via an Ethernet cable or an Ethernet bus 5.

The headlight 3 comprises a light source module 6 and a power control unit 7. The light source module 6 comprises an integrated circuit (IC) 8 having a plurality of light-emitting diodes arranged in the form of a matrix or array. The integrated circuit 8 is designed in particular as a solid-state LED array, preferably as an SSL chip, for example as an SSLIHD chip.

The integrated circuit 8 also has an Ethernet interface, not shown separately, which is set up to receive and further process the image data for the light-emitting diodes generated by the control device 2 and output via the Ethernet interface 4. The integrated circuit 8 also has current source drivers for supplying power to the light-emitting diodes. The integrated circuit 8 can be set up to convert the image data received via the Ethernet interface into pulse width modulation signals to control the current source drivers.

In addition to the integrated circuit 8, the light source module 6 has a converter component 9, which is connected to the Ethernet bus 5 on the one hand and to the integrated circuit 8 on the other. The converter component 9 adapts the voltage level of the incoming Ethernet signals via the Ethernet bus 5 to the voltage level of the integrated circuit 8. This converter component 9 does not change or decode the image data, but merely reduces the voltage amplitudes of the Ethernet signals.

The power control unit 7 comprises a power supply 10 for the light-emitting diodes and a control unit 11 that controls the power supply 10. The power control unit 7 is connected to the light source module 6 via a supply cable 12. The power control unit 7 is not used to control the light-emitting diodes with image data, but merely fulfills the function of a suitable voltage source for the integrated circuit 8 and the light-emitting diodes arranged on it.

### LIST OF REFERENCE NUMBERS

1 light control unit
2 control device
3 headlight
4 Ethernet interface of the light control unit
5 Ethernet bus
6 light source module
7 power control unit
8 integrated circuit
9 converter component
10 voltage supply
11 control unit
12 supply cable

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A headlight for a motor vehicle, comprising:
a light source module having a plurality of light-emitting diodes arranged in the form of a matrix or an array, wherein the plurality of light-emitting diodes is arranged to generate pixels of a light distribution, and
an Ethernet interface that is set up to receive and process image data for the light-emitting diodes, wherein the light source module has an integrated circuit on or in which both the plurality of light-emitting diodes and the Ethernet interface are formed.

2. The headlight according to claim 1, wherein the integrated circuit has current source drivers for supplying power to the light-emitting diodes.

3. The headlight according to claim 2, wherein the integrated circuit is set up to convert the image data received via the Ethernet interface into pulse width modulation signals for controlling the current source drivers.

4. The headlight according to claim 1, wherein the light source module has a converter component which adapts the voltage level of incoming Ethernet signals to the voltage level of the integrated circuit, wherein the converter component is arranged outside the integrated circuit.

5. The headlight according to claim 1, wherein the headlight comprises a power control unit which has a power supply for the light-emitting diodes and a control unit controlling the power supply, wherein the power control unit is connected to the light source module via a supply cable.

6. The headlight according to claim 1, wherein the integrated circuit is includes a solid-state LED array and an SSL chip.

7. A motor vehicle, comprising the headlight according to claim 1.

8. The motor vehicle according to claim 7, wherein the motor vehicle comprises a light control unit with a control device for controlling the plurality of light-emitting diodes of the headlight.

9. The motor vehicle according to claim 8, wherein the light control unit has an Ethernet interface for transmitting image data from the control device to the Ethernet interface arranged in the integrated circuit.

10. The motor vehicle according to claim 9, wherein the Ethernet interface of the light control unit and the Ethernet interface of the integrated circuit are connected to one another via an Ethernet cable or an Ethernet bus.
